(19) United States
(12) Patent Application Publication
(10) Pub. No.: US 2015/0062134 A1
(43) Pub. Date: Mar. 5, 2015

(54) PARAMETER FIFO FOR CONFIGURING VIDEO RELATED SETTINGS

(71) Applicant: Apple Inc., Cupertino, CA (US)

(72) Inventors: Peter F. Holland, Los Gatos, CA (US); Brijesh Tripathi, Los Altos, CA (US); Hao Chen, San Ramon, CA (US)

(73) Assignee: Apple Inc., Cupertino, CA (US)

(21) Appl. No.: 14/017,742

(22) Filed: Sep. 4, 2013

(51) Int. Cl. G06T 1/60; G06T 1/20

(52) U.S. Cl. CPC G06T 1/60; G06T 1/20
USPC 345/506; 345/545

(57) ABSTRACT

A graphics system may include one or more processing units for processing a current display frame, each processing unit including a plurality of parameter registers for storing parameter settings used in processing the current display frame. A parameter buffer in the graphics system may store frame packets, with each frame packet containing information corresponding to parameter settings to be used for at least one display frame. A control circuit coupled to the buffer and to the one or more processing units may retrieve a top frame packet from the parameter buffer and determine if the frame packet is an internal type, i.e., intended for internal registers in a respective processing unit or if it is an external type, i.e., intended for an external register elsewhere in the graphics system. Based on the type of frame packet, the control circuit may update one or more register values accordingly.

### BACKGROUND

1. Field of the Invention

This invention is related to the field of graphical information processing, and more particularly to reading and writing registers that store image frame descriptors.

2. Description of the Related Art

Part of the operation of many computer systems, including portable digital devices such as mobile phones, notebook computers and the like, is to employ a display device, such as a liquid crystal display (LCD), to display images, video information/streams, and data. Accordingly, these systems typically incorporate functionality for generating images and data, including video information, which are subsequently output to the display device. Such devices typically include video graphics circuitry to process images and video information for subsequent display.

In digital imaging, the smallest item of information in an image is called a “picture element,” more generally referred to as a “pixel.” For convenience, pixels are generally arranged in a regular two-dimensional grid. By using such an arrangement, many common operations can be implemented by uniformly applying the same operation to each pixel independently. Since each pixel is an elemental part of a digital image, a greater number of pixels can provide a more accurate representation of the digital image. To represent a specific color on an electronic display, each pixel may have three values, one each for the amounts of red, green, and blue present in the desired color. Some formats for electronic displays may also include a fourth value, called alpha, which represents the transparency of the pixel. This format is commonly referred to as ARGB or RGBA. Another format for representing pixel color is YCbCr, where Y corresponds to the luma, or brightness, of a pixel and Cb and Cr correspond to two color-difference chrominance components, representing the blue-difference (Cb) and red-difference (Cr).

Most images and video information displayed on display devices such as LCD screens are interpreted as a succession of ordered image frames, or frames for short. While generally a frame is one of the many still images that make up a complete moving picture or video stream, a frame can also be interpreted more broadly as simply a still image displayed on a digital (discrete or progressive scan) display. A frame typically consists of a specified number of pixels according to the resolution of the image/video frame. Most graphics systems use memories (commonly referred to as “frame buffers”) to store the pixels for image and video frame information. The information in a frame buffer typically consists of color values for every pixel to be displayed on the screen. Color values are commonly stored in 1-bit monochrome, 4-bit palletized, 8-bit palletized, 16-bit high color and 24-bit true color formats. An additional alpha channel is oftentimes used to retain information about pixel transparency.

In order for a video stream or animated image to appear to move smoothly, a constant interval between images is required. Without a constant interval, movement of objects and people in the video stream would appear erratic and unnatural. Before the use of LCD displays and digital video standards became common, analog cathode ray tube televisions and monitors used a signal called the Vertical Blanking Interval (VBI) to re-position the electron gun from the bottom right corner of the screen back to the top left where each video frame began. The VBI signal has continued to be present in modern video systems even though its original purpose is obsolete, and it can provide a constant interval for updating image frames.

### SUMMARY

Various embodiments of methods and apparatus for synchronizing parameter settings to a video stream are disclosed. Broadly speaking an apparatus and method are contemplated in which the apparatus includes a processing unit which may be configured to receive a plurality of source frames, a First-In-First-Out (FIFO) buffer which may include a plurality of entries, and a control unit coupled to the FIFO and the processing unit. The control unit may be configured to receive a plurality of frame packets, each of which may correspond to one of the source frames and each frame packet may include a header and one or more commands. The control unit may also be configured to store each frame packet in an entry of the FIFO buffer. In response to receiving a signal to process a new source frame, the control unit may be further configured to check the header of a frame packet in an entry of the FIFO buffer and determine if the given frame packet should be processed in parallel with the new source frame. If the frame packet should be processed, then the control unit may select one of at least two processing devices dependent upon a value in a command included in the given frame packet and send the command to the selected processing device.

In one embodiment, the header of a given frame packet may include a pointer to a given source frame and a count of commands within the frame packet. In a further embodiment, a command of the one or more commands of the given frame packet may include a command type indicator to be used by the control unit to select one of the at least two processing devices.

In a further embodiment, each source frame of the received source frames may comprise an image frame to be presented on an electronic display. The received signal may be a vertical blanking indicator (VBI).

### BRIEF DESCRIPTION OF THE DRAWINGS

The following detailed description makes reference to the accompanying drawings, which are now briefly described.

FIG. 1 is a block diagram of an embodiment of an integrated circuit that may include a graphics display system.

FIG. 2 is a block diagram of an embodiment of a display pipe in a graphics display system.

FIG. 3 is an illustration of an embodiment of a video frame and corresponding frame packet.

FIG. 4 is an illustration of an embodiment of a parameter FIFO frame packet format.

FIG. 5 is a flow diagram of an embodiment of a method for retrieving and executing frame packets from a parameter FIFO.

FIG. 6 is a flow diagram illustrating an embodiment of a method for executing parameter commands contained in a frame packet.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims. The headings used herein are for organizational purposes only and are not meant to be used to limit the scope of the description. As used throughout this application, the word “may” is used in a permissive sense (i.e., meaning having the potential to), rather than the mandatory sense (i.e., meaning must). Similarly, the words “include”, “including”, and “includes” mean including, but not limited to.

Various units, circuits, or other components may be described as “configured to” perform a task or tasks. In such contexts, “configured to” is a broad recitation of structure generally meaning “having circuitry that” performs the task or tasks during operation. As such, the unit/circuit/component can be configured to perform the task even when the unit/circuit/component is not currently on. In general, the circuitry that forms the structure corresponding to “configured to” may include hardware circuits and/or memory storing program instructions executable to implement the operation. The memory can include volatile memory such as static or dynamic random access memory and/or nonvolatile memory such as optical or magnetic disk storage, flash memory, programmable read-only memories, etc. Similarly, various units/circuits/components may be described as performing a task or tasks, for convenience in the description. Such descriptions should be interpreted as including the phrase “configured to.” Reciting a unit/circuit/component that is configured to perform one or more tasks is expressly intended not to invoke 35 U.S.C. §112, paragraph six interpretation for that unit/circuit/component.

### DETAILED DESCRIPTION OF EMBODIMENTS

In the following description, numerous specific details are set forth to provide a thorough understanding of the present invention. However, one having ordinary skill in the art should recognize that the invention might be practiced without these specific details. In some instances, well-known circuits, structures, and techniques have not been shown in detail to avoid obscuring the present invention.

Typically, raw video is received by a device (e.g., an integrated circuit (IC), such as a system-on-a-chip (SOC), or a package such as a multi-chip module (MCM)) of a computer system in a format that is not directly compatible with the electronic display to which a display controller of the device outputs frames to be displayed. In addition, the display controller may not accept the raw video format as input. Thus, at least some processing of input video may be performed by the device to convert the video input into a display-compatible format before outputting the video frames to the electronic display for viewing. For example, the device may be used to convert the video input from a raw video format (e.g., YUV420/1080p) to electronic display (e.g., ARGB) format frames of an appropriate size for viewing prior to feeding the video frames to the display controller. The display controller may perform additional rendering of the frames prior to feeding the frames to the electronic display.

In addition, there may be other parameters associated with a given frame or set of frame that may be used by the device for processing and displaying the frames on the electronic display. For example, brightness and or contrast levels may vary dependent upon user inputs or as an intended part of a video stream. One or more video input streams and one or more of these other parameters may be input for display concurrently. Some parameters may not be embedded within a video stream and, therefore, require synchronization with the video stream to display the images as intended. Synchronizing various parameters to a video source is challenging and may require additional host processor overhead without a method for automating the synchronization.

Thus, in addition to video processing, another function that may be performed by the device is combining these different parameters into output frames to be presented on the electronic display simultaneously. These different parameters may be directed to a display processor itself, or may need to be sent to various other functional blocks in an SoC. The embodiments illustrated in the drawings and described below may provide techniques to organize, process, and synchronize various display parameters within and external to a display processor. The embodiments may provide a convenient method for distributing parameters among the display controller and other modules related to a video stream while maintaining synchronization to a given video source and minimizing additional workload to the host processor.

### System Overview

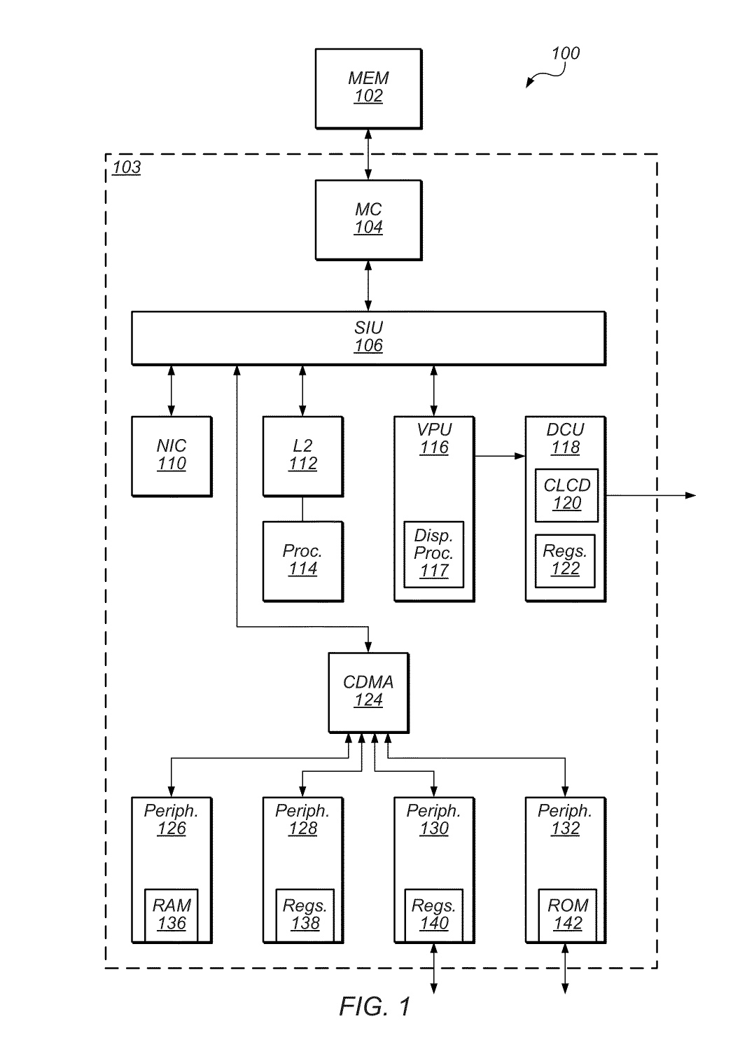

Turning now to FIG. 1, a block diagram of one embodiment of a system 100 that includes an integrated circuit 103 coupled to external memory 102 is shown. In the illustrated embodiment, integrated circuit 103 includes a memory controller 104, a system interface unit (SIU) 106, a set of peripheral components such as components 126-128, a central DMA (CDMA) controller 124, a network interface controller (NIC) 110, a processor 114 with a level 2 (L2) cache 112, and a video processing unit (VPU) 116 coupled to a display control unit (DCU) 118. One or more of the peripheral components may include memories, such as random access memory (RAM) 136 in peripheral component 126 and read-only memory (ROM) 142 in peripheral component 132. One or more peripheral components 126-132 may also include registers (e.g. registers 138 in peripheral component 128 and registers 140 in peripheral component 130 in FIG. 1). Memory controller 104 is coupled to a memory interface, which may couple to memory 102, and is also coupled to SIU 106. CDMA controller 124, and L2 cache 112 are also coupled to SIU 106 in the illustrated embodiment. L2 cache 112 is coupled to processor 114, and CDMA controller 124 is coupled to peripheral components 126-132. One or more peripheral components 126-132, such as peripheral components 140 and 142, may be coupled to external interfaces as well.

SIU 106 may be an interconnect over which the memory controller 104, peripheral components NIC 110 and VPU 116, processor 114 (through L2 cache 112), L2 cache 112, and CDMA controller 124 may communicate. SIU 106 may implement any type of interconnect (e.g. a bus, a packet interface, point to point links, etc.). SIU 106 may be a hierarchy of interconnects, in some embodiments. CDMA controller 124 may be configured to perform DMA operations between memory 102 and/or various peripheral components 126-132. NIC 110 and VPU 116 may be coupled to SIU 106 directly and may perform their own data transfers to/from memory 102, as needed. NIC 110 and VPU 116 may include their own DMA controllers, for example. In other embodiments, NIC 110 and VPU 116 may also perform transfers through CDMA controller 124. Various embodiments may include any number of peripheral components coupled through the CDMA controller 124 and/or directly to the SIU 106. VPU 116 may include a display processor 117. DCU 118 may include a display control unit (CLDC) 120 and buffers/registers 122. CLDC 120 may provide image/video data to a display, such as a liquid crystal display (LCD), for example. DCU 118 may receive the image/video data from VPU 116, which may obtain image/video frame information from memory 102 as required, to produce the image/video data for display, provided to DCU 118.

Instructions executed by Processor 114 may program CDMA controller 124 to perform DMA operations. Various embodiments may program CDMA controller 124 in various ways. For example, DMA descriptors may be written to the memory 102, describing the DMA operations to be performed, and CDMA controller 124 may include registers that are programmable to locate the DMA descriptors in the memory 102. The DMA descriptors may include data indicating the source and target of the DMA operation, where the DMA operation transfers data from the source to the target. The size of the DMA transfer (i.e., the number of bytes) may be indicated in the descriptor. Termination handling (e.g. interrupt the processor, write the descriptor to indicate termination, etc.) may be specified in the descriptor. Multiple descriptors may be created for a DMA channel, and the DMA operations described in the descriptors may be performed as specified. Alternatively, the CDMA controller 124 may include registers that are programmable to describe the DMA operations to be performed, and programming the CDMA controller 124 may include writing the registers.

Generally, a DMA operation may be a transfer of data from a source to a target that is performed without involvement from a processor, such as Processor 114. At least one of the source and target may be a memory. The memory may be the system memory (e.g. the memory 102), or may, in some embodiments, be an internal memory in the integrated circuit 103. For example, a peripheral component 126-132 may include a memory that may be a source or target. In the illustrated embodiment, peripheral component 132 includes the ROM 142 that may be a source of a DMA operation. Some DMA operations may have memory as a source and a target (e.g. a first memory region in memory 102 may store the data to be transferred and a second memory region may be the target to which the data may be transferred). Other DMA operations may have a peripheral component as a source or target. The peripheral component may be coupled to an external interface on which the DMA data is to be transferred or on which the DMA data is to be received. For example, peripheral components 130 and 132 may be coupled to interfaces onto which DMA data is to be transferred or on which the DMA data is to be received.

In one embodiment, instructions executed by the processor 114 may also communicate with one or more of peripheral components 126-132, NIC 110, VPU 116, and/or the various memories such as memory 102, or ROM 142 using read and/or write operations referred to as programmed input/output (PIO) operations. The PIO operations may have an address that is mapped by integrated circuit 103 to a peripheral component 126-132, NIC 110, or VPU 116 (and more particularly, to a register or other readable/writeable resource, such as ROM 142 or Registers 138 in the component, for example). It should also be noted, that while not explicitly shown in FIG. 1, NIC 110 and VPU 116 may also include registers or other readable/writeable resources which may be involved in PIO operations. PIO operations directed to memory 102 may have an address that is mapped by integrated circuit 103 to memory 102. Alternatively, the PIO operation may be transmitted by processor 114 in a fashion that is distinguishable from memory read/write operations (e.g. using a different command encoding then memory read/write operations on SIU 106, using a sideband signal or control signal to indicate memory vs. PIO, etc.). The PIO transmission may still include the address, which may identify the peripheral component 126-132, NIC 110, or VPU 116 (and the addressed resource) or memory 102 within a PIO address space, for such implementations.

In one embodiment, PIO operations may use the same interconnect as CDMA controller 124, and may flow through CDMA controller 124, for peripheral components that are coupled to CDMA controller 124. Thus, a PIO operation may be issued by processor 114 onto SIU 106 (through L2 cache 112, in this embodiment), to CDMA controller 124, and to the targeted peripheral component. Alternatively, the peripheral components 126-132 may be coupled to SIU 106 (much like NIC 110 and VPU 116) for PIO communications. PIO operations to peripheral components 126-132 may flow to the components directly from SIU 106 (i.e. not through CDMA controller 124) in one embodiment.

Generally, a peripheral component may comprise any desired circuitry to be included within system 100 with the processor. A peripheral component may have a defined functionality and interface by which other components of integrated circuit 103 may communicate with the peripheral component. For example, a peripheral component such as VPU 116 may include video components such as a display pipe, which may include graphics processors, and a peripheral such as DCU 118 may include other video components such as display controller circuitry. NIC 110 may include networking components such as an Ethernet media access controller (MAC) or a wireless fidelity (WiFi) controller. Other peripherals may include audio components such as digital signal processors, mixers, etc., controllers to communicate on various interfaces such as universal serial bus (USB), peripheral component interconnect (PCI) or its variants such as PCI express (PCIe), serial peripheral interface (SPI), flash memory interface, etc.

As mentioned previously, one or more of the peripheral components 126-132, NIC 110 and VPU 116 may include registers that may be addressable via PIO operations. These registers may include configuration registers that configure programmable options of the peripheral components (e.g. programmable options for video and image processing in VPU 116), status registers that may be read to indicate status of the peripheral components, etc.

Memory controller 104 may be configured to receive memory requests from system interface unit 106. Memory controller 104 may be configured to access memory to complete the requests (writing received data to the memory for a write request, or providing data from memory 102 in response to a read request) using the interface defined the attached memory 102. Memory controller 104 may be configured to interface with any type of memory 102, such as dynamic random access memory (DRAM), synchronous DRAM (SDRAM), double data rate (DDR, DDR2, DDR3, etc.) SDRAM, Low Power DDR2 (LPDDR2) SDRAM, RAMBUS DRAM (RDRAM), static RAM (SRAM), etc. The memory may be arranged as multiple banks of memory, such as dual inline memory modules (DIMMs), single inline memory modules (SIMMs), etc. In one embodiment, one or more memory chips are attached to the integrated circuit 10 in a package on package (POP) or chip-on-chip (COC) configuration.

It is noted that other embodiments may include other combinations of components, including subsets or supersets of the components shown in FIG. 1 and/or other components. While one instance of a given component may be shown in FIG. 1, other embodiments may include one or more instances of the given component.

### Display Processor Overview

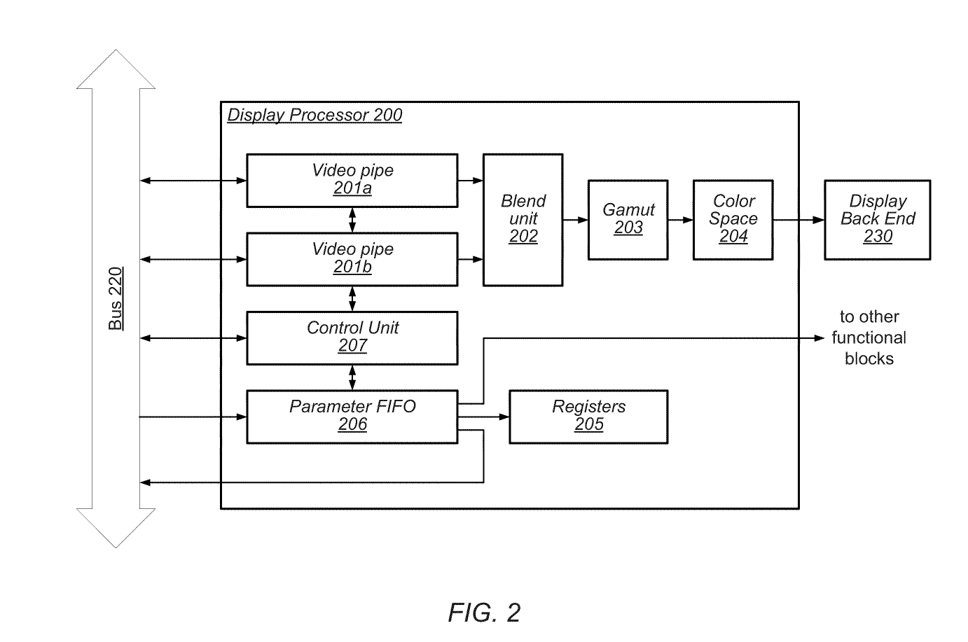

FIG. 2 illustrates an embodiment of a display processor 200. Display processor 200 may represent display processor 117 included in VPU 116 in FIG. 1. Display processor 200 may be coupled to a system bus 220 and to a display back end 230. Display processor 200 may include functional sub-blocks such as one or more video pipelines 201a-b, coupled to system bus 220, blending unit 202, coupled to video pipelines 201, gamut adjustment block 203, coupled to blending unit 202, color space converter 204, coupled to gamut adjustment block 203 and coupled to display back end 230. Display processor 200 may also include control registers 205, coupled to the various sub-blocks in display controller 200, and a parameter First-In, First-Out buffer (FIFO) 206, coupled to system bus 220 and control registers 205. Display processor 200 may include a control unit 207, coupled to the parameter FIFO and other sub-blocks.

System bus 220, in some embodiments, may correspond to I/O interface 130 from FIG. 1. System bus 220 couples various functional blocks such that the functional blocks may pass data between one another. Display controller 200 may be coupled to system bus 220 in order to receive video frame data for processing. In some embodiments, display processor 200 may also send processed video frames to other functional blocks and or memory that may also be coupled to system bus 220.

Display back end 230 may receive processed image data as each pixel is processed by display processor 200. Display back end 230 may provide final processing to the image data before each video frame is displayed. In some embodiments, display back end may include ambient-adaptive pixel (AAP) modification, dynamic backlight control (DPB), display panel gamma correction, and dithering specific to an electronic display coupled to display back end 230.

The display processor 200 may include one or more video pipelines 201a-b. Each video pipeline 201 may fetch a video frame from a buffer coupled to system bus 220. The buffered video frame may reside in a system memory such as, for example, system memory 120 from FIG. 1. Each video pipeline 201 may fetch a distinct image and may process its image in various ways, including, but not limited to, format conversion, such as, for example, YCbCr to ARGB, image scaling, and dithering. In some embodiments, each video pipeline may process one pixel at a time, in a specific order from the video frame, outputting a stream of pixel data, maintaining the same order as pixel data passes through.

The output from video pipelines 201 may be passed on to blending unit 202. Blending unit 202 may receive a pixel stream from one or more video pipelines. If only one pixel stream is received, blending unit 202 may simply pass the stream through to the next sub-block. However, if more than one pixel stream is received, blending unit 202 may blend the pixel colors together to create an image to be displayed. In various embodiments, blending unit 202 may be used to transition from one image to another or to display a notification window on top of an active application window. For example, a top layer video frame for a notification, such as, for a calendar reminder, may need to appear on top of, i.e., as a primary element in the display, despite a different application, an internet browser window for example. The calendar reminder may comprise some transparent or semi-transparent elements in which the browser window may be at least partially visible, which may require blending unit 202 to adjust the appearance of the browser window based on the color and transparency of the calendar reminder. The output of blending unit 202 may be a single pixel stream composite of the one or more input pixel streams.

The output of blending unit 202 may be sent to gamut adjustment unit 203. Gamut adjustment 203 may adjust the color mapping of the output of blending unit 202 to better match the available color of the intended target display.

The output of gamut adjustment unit 203 may be sent to color space converter 204. Color space converter 204 may take the pixel stream output from gamut adjustment unit 203 and convert it to a new color space. Color space converter 204 may then send the pixel stream to display back end 230 or back onto system bus 220. In other embodiments, the pixel stream may be sent to other target destinations. For example, the pixel stream may be sent to a network interface, such as network interface 140 from FIG. 1, for example. In some embodiments, new color space may be chosen based on the mix of colors after blending and gamut corrections have been applied. In further embodiments, the color space may be changed based on the intended target display.

The parameters that display processor 200 may use to control how the various sub-blocks manipulate the video frame may be stored in control registers 205. These registers may include, but not limited to, setting input and output frame sizes, setting input and output pixel formats, location of the source frames, and destination of the output (display back end 230 or system bus 220). Values for these control registers 205 may be received from parameter FIFO 206.

Parameter FIFO 206 may store commands for updating registers such as control registers 205. The commands may be stored in data structures referred to as frame packets. Each frame packet may include settings for one or more control registers 205. In further embodiments, a given frame packet may alternatively include settings for registers outside of display processor 200. In such embodiments, system bus 220 may be used to transport the parameter settings to the targeted registers.

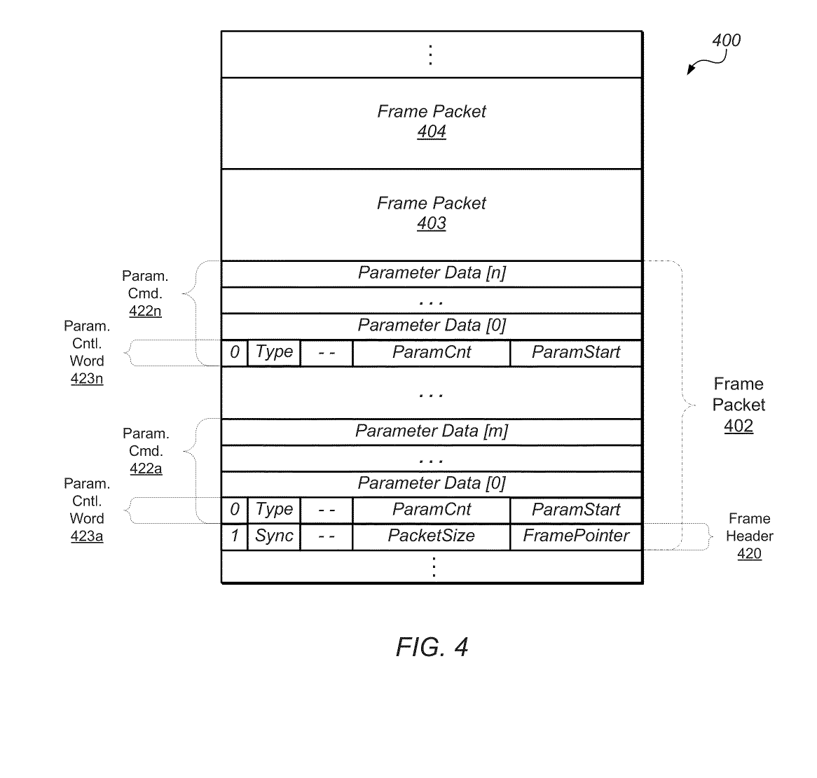

Parameter FIFO 206 may select the destination of commands included in the frame packets. In some embodiments, parameter FIFO 206 may receive a signal from control unit 207 that determines the destination of the commands in the frame packet. In other embodiments, logic circuits within parameter FIFO may be configured to select an output path from multiple possible paths dependent upon frame packets as described below in reference to FIG. 4. For instance, a destination may be registers internal to display processor 200. In some embodiments, another destination may be bus 220 which may, in turn, allow access to any functional block coupled to the bus. In further embodiments, the destination may be another functional block through an interface that bypasses bus 220.

The frame packets may be written to parameter FIFO 206 by a host processor, a direct memory access unit, a graphics processing unit, or any other suitable processor within the computing system. In other embodiments, parameter FIFO 206 may directly fetch frame packets from a system memory, such as, e.g., system memory 120 in FIG. 1. Parameter FIFO 206 may be configured to process frame packets before each video frame is fetched. In some embodiments, frame packets may update all control registers 205 for each frame. In other embodiments, frame packets may update subsets of control registers 205, including all or none for each frame.

A FIFO as used and described herein, may refer to a memory storage buffer in which data stored in the buffer is read in the same order it was written. A FIFO may be comprised of RAM or registers and may utilize pointers to the first and last entries in the FIFO.

Control unit 207 may control the operation of parameter FIFO 206, including controlling the loading of frame packets into the FIFO buffer and reading frame packets from the FIFO buffer and processing the commands included in the frame packets. Control unit 207 may receive a signal to indicate a new video frame is ready for processing. In some embodiments, this signal be generated outside of display processor 200 and in other embodiments display processor 200 may generate the signal. More details on the operation of control unit will be provided below.

It is noted that the display processor illustrated in FIG. 2 is merely an example. In other embodiments, different functional blocks and different configurations of functions blocks may be possible dependent upon the specific application for which the display processor is intended. For example, more than two video pipelines may be included.

### Video Frames and Frame Packets

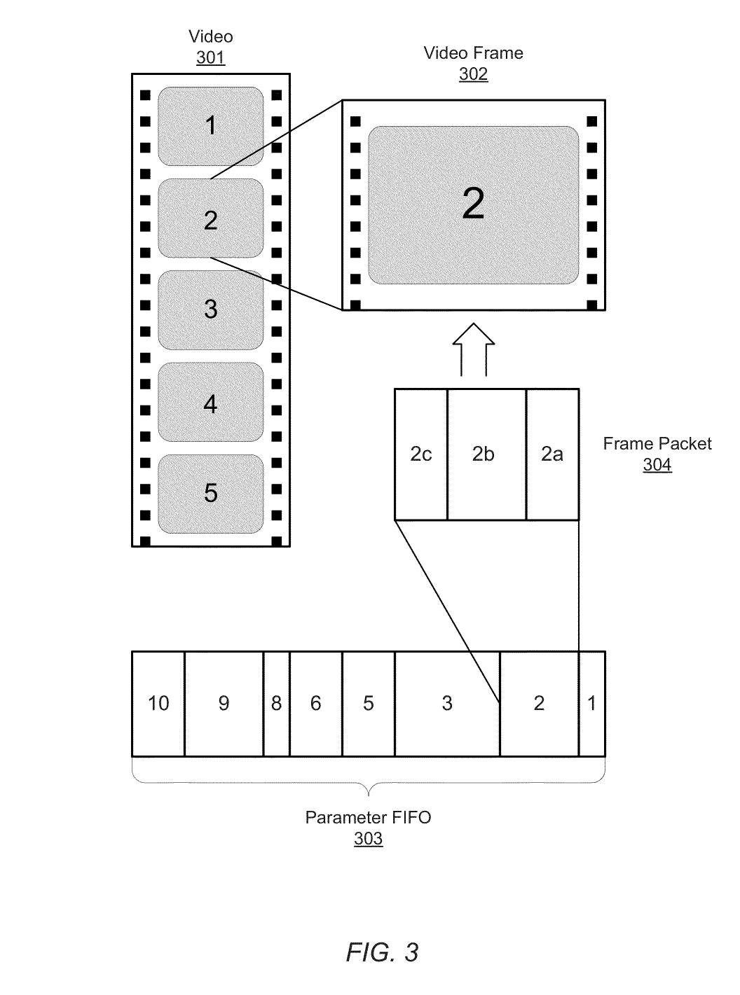

Turning to FIG. 3, a representation of a video file and a corresponding parameter FIFO, as might be used in system 100, are illustrated. In various embodiments, video 301 may represent a file containing a video clip in a format, such as, for example, Moving Pictures Expert Group-4 Part 14 (MP4), Advanced Video Coding (H.264/AVC), or Audio Video Interleave (AVI). Alternatively, Video 301 may be a series of still images, each image considered a frame, that may be displayed in timed intervals, commonly referred to as a slideshow. The images may be in a format such as Joint Photographic Experts Group (JPEG), raw image format (RAW), Graphics Interchange Format (GIF), or Portable Networks Graphics (PNG). For demonstration purposes, Video 301 is illustrated with five frames, numbered 1 through 5. However, any number of frames may be included in Video 301.

Video frame 302 may represent a single frame from video 301. In this example, video frame 302 is illustrated as frame number 2 of video 301. Video frame 302 may be a single image, in any of the formats previously discussed or any other suitable format. Video frame 302 may contain a list of pixel information in ARGB, YCbCr, or other suitable pixel format.

Parameter FIFO 303 may correspond to parameter FIFO 206 as illustrated in FIG. 2 and may have functionality as previously described. For demonstration purposes, parameter FIFO 303 is illustrated in FIG. 3 as holding eight frame packets, numbered 1 through 10, with 4 and 7 excluded. However, parameter FIFO may hold as many frame packets as allowed by the size of the FIFO and the size of the frame packets. The number of the frame packet may correspond to the number of the video frame of video 301 for which the packet is intended to be used. Frame packets 4 and 7 are excluded to illustrate that some video frames may not require a frame packet. In other embodiments, a frame packet may be required for each video frame. The size of each of the frame packets is shown to vary among the 10 examples to illustrate that the sizes may differ from frame packet to frame packet. In other embodiments, each frame packet may be a standard consistent size.

Frame packet 304 may represent a single frame packet stored in Parameter FIFO 304. Frame packet 304 may contain settings for various registers associated with a given video frame. In this example, frame packet 304 is shown as number 2 which may correspond to video frame 302, also illustrated as number 2. Frame packet 304 is illustrated as being divided into three sections, labeled 2a, 2b, and 2c, each representing one parameter command. A given frame packet may include any number of parameter commands, from zero to as many as may be stored in parameter FIFO 303. Each parameter command 2a-2c may contain a setting for one or more registers associated with video frame 302. Parameter commands 2a-2c may be of various lengths, based on the number of settings included in each command. In other embodiments, parameter commands 2a-2c may be standardized to one or more specific lengths.

In a system such as system 100 in FIG. 1, VPU 116 may process video frame 302 and frame packet 304 such that parameter commands 2a-2c are executed after video frame 1 of video 301 has been displayed and before video frame 2, i.e., video frame 302, is displayed, such that video frame 302 is displayed with parameters corresponding to parameter commands 2a-2c. These parameters may remain at their set values until another parameter command is executed that changes their currently set value. In some embodiments, the values of some or all parameters may be modified by commands not associated with parameter FIFO 303, such as, for example, PIO operations transmitted by processor 114.

A more detailed view of a frame packet, such as frame packet 304, may be seen in FIG. 4. FIG. 4 may illustrate the entries in a parameter FIFO, such as parameter FIFO 303 in FIG. 3. Parameter FIFO entries 400 may include several frame packets, as illustrated by frame packets 402, 403, and 404.

Frame packet 402 may, in some embodiments, include frame header 420 and be followed by a number of parameter commands, such as parameter command 422a through parameter command 422n as depicted in FIG. 4. A given frame packet may contain zero parameter commands up to the maximum number of commands that may fit into a FIFO of a given size. A frame packet with zero parameter commands may be referred to as a null parameter setting. Frame packet 402 may be read from parameter FIFO 303 when all frame packets written to parameter FIFO 303 before frame packet 402 have been read. When frame packet 402 is read, the first word read may be frame header 420.

Frame header 420 may contain information regarding the structure of frame packet 402. For example, frame header 420 may include a value corresponding to the size of frame packet 402. In some embodiments, the size may represent the number of bytes or words in the frame packet 402 and, in other embodiments, the size may represent the number of parameter commands. Frame header 420 may also include a value corresponding to the video frame for which it is intended. In various embodiments, frame header 420 may include a value to indicate that it is a frame header and/or a value to indicate frame packet 420 should be used with the next video frame to be processed rather than a specific video frame. This last feature may be useful in cases where a user of system 100 adjusts a setting while a video is playing or an image is being displayed. For example, a user may change a brightness setting or a zoom factor with an expectation of the change being implemented as soon as possible rather than at a specific video frame.

Frame packet 402 may include zero or more parameter commands 422a-n. In some embodiments, a given parameter command, such as, for example, parameter command 422a, may include one parameter control word 423a. The parameter control word may define the structure of parameter command 422a. For example, parameter control word 423a may include a parameter count value to indicate how many parameter settings are included in the command. Parameter control word 423a may also include a parameter start value to indicate a starting register address for the parameter settings to be written. Some embodiments may also include a type value to indicate if parameter command 422a is internal, i.e., intended for registers within the display processor, such as display processor 200, or external, i.e., intended for registers outside display processor 200. In some embodiments, the parameter start value may only be used for internal parameter commands, where the registers may be addressed with an address value smaller than a complete data word. In such embodiments, external commands may use the first one or more words of the parameter data to form a starting address for the register(s) to be written with the remaining parameter data.

Each parameter setting within parameter command 422a may include one or more words of parameter data, shown in FIG. 4 as parameter data [0] through parameter data [m]. The number of parameter data words included in parameter command 422a may depend on the type of parameter command, internal or external, and the number of registers to be written by parameter command 422a. In various embodiments, parameter commands 422 may include various numbers of parameter data or may be standardized to a specific number of parameter data.

It is noted that the descriptions of frame packets, video frames and the parameter FIFO in FIG. 3 and FIG. 4 are merely examples. In other embodiments, the structure of a frame packet may include multiple words for header rather than the single word illustrated in FIG. 4, and a header may not be the first word within a given frame packet. In various embodiments, frame packets and parameter commands may be of a fixed length rather than various lengths as illustrated in FIGS. 3 and 4.

### Method for Operating a Parameter FIFO

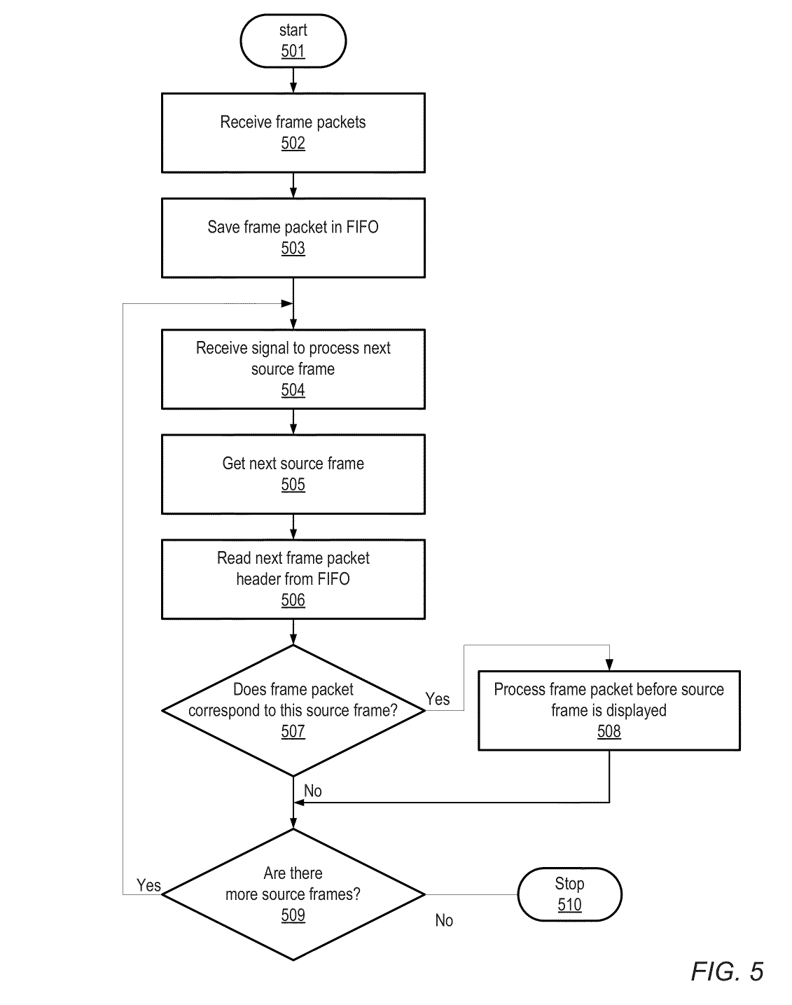

Turning to FIG. 5, a flow chart depicting a method for controlling an embodiment of a parameter FIFO is illustrated. The method may correspond to a parameter FIFO and control logic such as, for example, parameter FIFO 206 and control unit 207 in FIG. 2, and may include frame packets such as illustrated in FIGS. 3 and 4, for example. Referring collectively to FIG. 5 and the previously discussed figures, the method may begin in block 501.

Before any frame packets are executed, they must first be stored in parameter FIFO 206. Display processor 200 may receive frame packet 304 from system bus 220 (block 502). In some embodiments, frame packet 304 may be received as a result of one or more PIO operations transmitted by processor 114. In other embodiments, frame packet 402 may be received as a result of one or more CDMA 124 memory transfers. Additional frame packets may also be received by the same method. The method may next move to block 503 once all frame packets have been received or parameter FIFO 206 is full.

Control unit 207 may store the received frame packets 402-404 in parameter FIFO 206 (block 503). Each frame packet may be stored in the order it was received. In some embodiments, when parameter FIFO 206 reaches a maximum capacity for storing frame packets, a value may be set in a register associated with parameter FIFO 206 to indicate such. Upon frame packets being read and removed from parameter FIFO 206, the status value may change to indicate available space for additional frame packets.

A signal may be received by display processor 200 to indicate that it is time to process the next video frame (block 504). In some embodiments, the signal may correspond to a VBI signal. Display controller 200 may relay the received signal to control unit 207. The method may next move to block 505.

In response to receiving the signal to process the next video frame, display processor 200 may fetch the next video frame (block 505). The video frame may correspond to video frame 302 in FIG. 3. Video frame 302 may be stored in a buffer in system memory, such as RAM 136, or in other embodiments, video frame 302 may be stored in a buffer of a peripheral such as a camera or a USB module. The video frame may be in any video format supported by system 100. Display processor may prepare the video frame for a display by converting it from a received format into a format required by the display. Other preparations may include limiting the pixels to be displayed to correspond to a zoom level and/or blending the pixels with another image to correspond to a transparency/alpha level. Once the video frame is prepared for the display, it may be sent to the display by display processor 200.

Concurrent to the processing of video frame 302, control unit 207 may access the next entry in parameter FIFO 206 and read frame header 420 (block 506). Frame header 420 may include information about frame packet 304, including to which video frame it corresponds. In some embodiments, frame header 420 may include a value to indicate frame packet 304 is to be processed with the next available video frame.

Control unit 207 may determine if frame packet 304 should be processed with video frame 302 (block 507). If not, then frame packet 304 will remain in parameter FIFO 206 and the method may move to block 509. If frame packet 304 is to be processed with video frame 302, then the method may move to block 508.

Control unit 207 may process frame packet 304 before video frame 302 is presented on the display (block 508). Control unit 207 may process frame packet 304 while display processor 200 processes video frame 302. In other embodiments, display processor 200 may complete processing video frame 302 before control unit 207 processes frame packet 304. Once both video frame 302 and frame pack packet 304 have been processed, the method may move to block 508.

Display processor 200 may determine if more video frames are to be processed (block 509). If more video frames are to be processed, then the method may return to block 504 to await the next signal. Otherwise, the method may end in block 510.

The method of FIG. 5 is merely illustrative and is not intended to limit the scope of the embodiments. It is noted that although the steps of the method are depicted as being performed in a sequential order, in other embodiments, some of the steps may performed in parallel and or in a different order.

### Method for Processing a Frame Packet

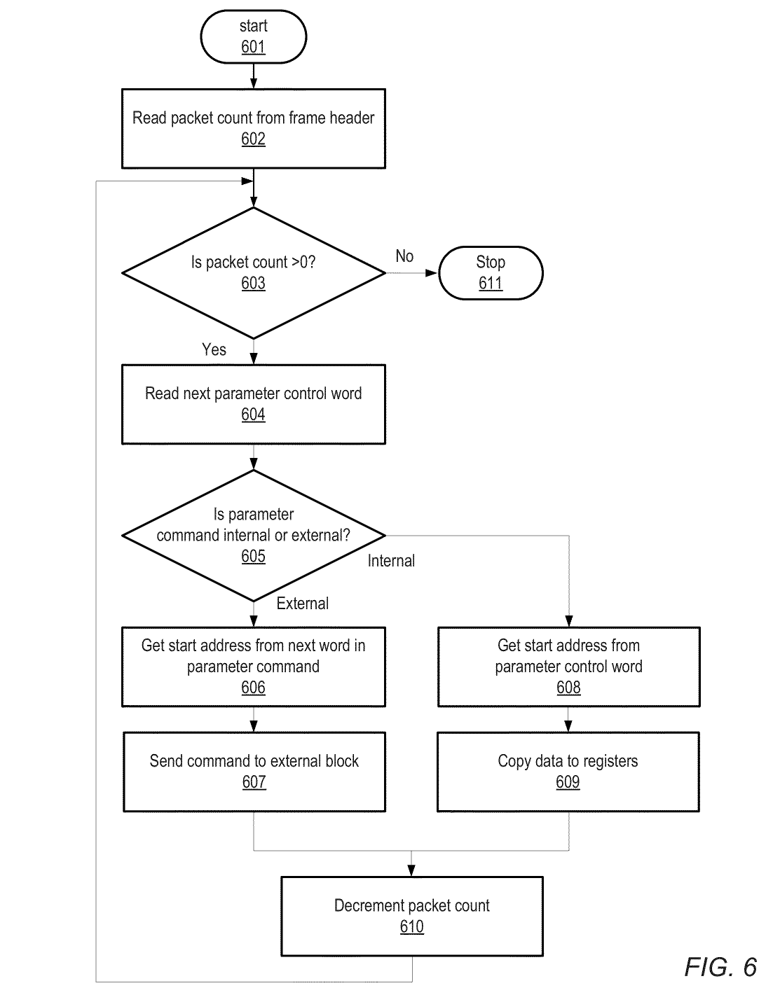

Moving to FIG. 6, a flow chart depicting a method for processing a frame packet by an embodiment of a parameter FIFO, such as, for example, parameter FIFO 206 in FIG. 2, is illustrated. This method may, in some embodiments, correspond to block 508 as depicted in FIG. 5, and may include frame packets, such as those illustrated in FIGS. 3 and 4, for example. Referring collectively to FIG. 6 and the previously discussed figures, the method may begin in block 601.

A packet count for the frame packet being processed, such as frame packet 304 may be read from frame packet header 420 (block 602). In some embodiments, frame packet header 420 may include a number of bytes or words in frame packet 304 and, in other embodiments, a number of parameter commands may be included.

The method may determine if the parameter count is greater than zero (block 603). Since zero may be a valid value for the parameter count in some embodiments, control logic associated with parameter FIFO 206 must determine if there are any parameter commands to process. If the number of parameter commands is zero, then the method may stop in block 611. If the number of parameter commands is one or more, then the method may move to block 604.

Once control logic for parameter FIFO 206 has determined at least one parameter command is in frame packet 304, the next parameter control word, such as parameter control word 423a, may be read (block 604). Parameter control word 423a may correspond to parameter command 422a in FIG. 4. Parameter control word 423a may include several values relevant to the processing of parameter command 422a, such as, for example, a count of the number of parameters to be updated and a starting address for the first parameter to be updated. Some embodiments may include a value to indicate a type of parameter command, such as internal or external, as described previously.

The method may then determine if parameter command 422a is an internal or an external command (block 605). If the parameter command is an internal command, the method may move to block 608. If it is an external command, then the method may move to block 606.

If parameter command 422a is an external command, then the starting address may be read from the first one or more parameter data words, such as parameter data [0] as shown in FIG. 4 (block 606). An external parameter command may update parameters outside display processor 200 and outside of VPU 116 in FIG. 1. In some embodiments, an external parameter command may write to any memory-mapped register in system 100. In such an embodiment, a full address value may be required and a full address value may not fit in parameter control word 423a with the other values such as the parameter count and the type indicator. Therefore, an external parameter command may store the parameter starting address value in parameter data [0]. Once the starting address has been read, the method may move to block 608.

Using the starting address, the method may send the command to the functional block at that address (block 608). An external parameter command may be more than a new register value. In some embodiments, an external parameter command may be an executable instruction to another processor in the system. In further embodiments, an external parameter command may set a specific state within a state machine or may signal a functional block to begin or to cease operation. The exact behavioral response may be determined by the functional block receiving the external parameter command. After sending the command, the method may move to block 610.

If parameter command 422a is an internal command, then the starting address may be read from parameter control word 423a (block 608). An internal command may be limited to updating registers within display processor 200 and VPU 116. In such embodiments, a full address may not be required and the starting address for the local parameters may fit within parameter control word 423a. Once the starting address has been read, the method may move to block 609.

Control logic for parameter FIFO 206 may copy parameter data to registers, beginning with the starting address that has just been read (block 609). Parameter data [0] through parameter data [m] may be copied into the local registers. Registers may be updated sequentially, beginning at the starting address corresponding to parameter command 422a. Various embodiments are known and may include incrementing or decrementing the address after the starting address and the parameter data may be of any word size supported by system 100, e.g., 8-bit, 16-bit, 32-bit, etc. Once the last parameter data word has been copied (parameter data [m] in the example of parameter command 422a), the method may move to block 610.

Once parameter data [m] has been copied, control logic for parameter FIFO 206 may decrement the packet count read from frame header 420 (block 610). The method may return to block 603 to determine if more parameter commands are included in frame packet 402. Once the packet count reaches zero, the method may end in block 611.

The method of FIG. 6 is an example. In other embodiments, different operations and different orders of operations are possible and contemplated.

Numerous variations and modifications will become apparent to those skilled in the art once the above disclosure is fully appreciated. It is intended that the following claims be interpreted to embrace all such variations and modifications.

What is claimed is:

1. A system for processing data, comprising:
a memory configured to store a sequentially ordered plurality of data frames;
a data processor coupled to the memory, wherein the data processor is configured to retrieve and process a given data frame of the sequentially ordered plurality of data frames;
a First-In First-Out (FIFO) buffer, wherein the FIFO buffer includes a sequentially ordered plurality of entries, wherein each entry of the sequentially ordered plurality of entries is configured to store a respective one of a plurality of frame packets;
a control circuit coupled to the FIFO buffer and the data processor, wherein the control circuit is configured to:
receive a signal indicating the data processor has retrieved and is processing the given data frame of the sequentially ordered plurality of data frames;
retrieve a next frame packet from a next entry of the sequentially ordered plurality of entries;
select one of two or more processing units responsive to a determination that the retrieved frame packet is associated with the given data frame; and
send the retrieved frame packet to the selected one of the two or more processing units.

2. The system of claim 1, wherein each frame packet of the plurality of frame packets includes a header and one or more command words, wherein each command word is associated with one or more command data values.

3. The system of claim 2, wherein the two or more processing units includes at least one processing unit external to the system for processing data.

4. The system of claim 1, wherein the sequentially ordered plurality of data frames comprises a sequentially ordered plurality of image frames for use on an electronic display.

5. The system of claim 2, wherein to send the retrieved frame packet to the selected one of the two or more processing units, the control circuit is further configured to send commands to the selected one of the two or more processing units dependent upon the command data values associated with the command word that selected the processor.

6. The system of claim 2, wherein the header of each frame packet of the plurality of frame packets includes a value to identify an associated data frame of the sequentially ordered plurality of data frames.

7. The system of claim 2, wherein each header of each frame packet of the plurality of frame packets includes a flag to indicate the contents associated with the frame packet will be processed with the next data frame of the sequentially ordered plurality of data frames.

8. A method for operating a processing pipeline, comprising:
receiving a sequentially ordered plurality of source frames;
receiving a sequentially ordered plurality of frame packets wherein each frame packet of the sequentially ordered plurality of frame packets includes a control word and one or more data words;
storing each frame packet of the received sequentially ordered plurality of frame packets;
processing a given source frame of the received sequentially ordered plurality of source frames;
receiving a signal indicating the given source frame is being processed;
retrieving, responsive to receiving the signal indicating the given source frame is being processed, a next frame packet from the stored sequentially ordered plurality of frame packets;
determining if the retrieved frame packet should be processed in parallel with the given source frame;
selecting one of at least two processing units dependent upon at least one of the one or more data words included in the retrieved frame packet, wherein the at least two processing units includes at least one processing unit external to the processing pipeline; and
updating one or more registers in the selected one of the at least two processing devices dependent upon the at least one data word of the one or more data words included in the retrieved frame packet.

9. The method of claim 8, wherein the control word of a given frame packet of the received sequentially ordered plurality of frame packets, includes a pointer to a given source frame, and a count of data words within the given frame packet.

10. The method of claim 8, wherein one of the one or more data words of the retrieved frame packet includes a command type indicator.

11. The method of claim 8, wherein the sequentially ordered plurality of source frames comprise a sequentially ordered plurality of images to be presented on an electronic display.

12. The method of claim 11, wherein the received signal is a vertical blanking indicator (VBI).

13. The method of claim 8, wherein a given frame packet of the received sequentially ordered plurality of frame packets comprises more than one control word and each control word has one or more associated data words.

14. The method of claim 8, wherein the control word of a given one of the received sequentially ordered plurality of frame packets includes a null command.

15. An apparatus, comprising:
a processing unit configured to receive and process a given source frame of a sequentially ordered plurality of source frames;
a buffer, wherein the buffer includes a sequentially ordered plurality of entries wherein each entry is configured to store a frame packet of a sequentially ordered plurality of frame packets, wherein each frame packet includes a header and one or more commands
a control unit coupled to the processing unit and the buffer, wherein the control unit is configured to:
receive a signal indicating a subsequent source frame is to be retrieved and processed;
retrieve a next frame packet stored in a next entry of the sequentially ordered plurality of entries responsive to receiving the signal;
determine if the retrieved frame packet should be processed in parallel with the subsequent source frame dependent upon a check of the header of the retrieved frame packet;
select one of at least two processing devices dependent upon at least one command of the one or more commands included in the retrieved frame packet, wherein the at least two processing devices includes at least one processing device external to the apparatus; and
send the at least one command of the one or more commands included in the retrieved frame packet to the selected one of the at least two processing devices.

16. The apparatus of claim 15, wherein the header of each frame packet of the sequentially ordered plurality of frame packets includes a pointer to a given source frame of the sequentially ordered plurality of source frames, and a count of commands within the frame packet.

17. The apparatus of claim 15, wherein each command of the one or more commands of each frame packet of the sequentially ordered plurality of frame packets includes a command type indicator, and wherein to select one of the at least two processing devices, the control unit is further configured to check the command type indicator of the command of the one or more commands of the next frame packet.

18. The apparatus of claim 15, wherein each source frame of the received sequentially ordered plurality of source frames comprises an image frame, wherein the image frame is to be presented on an electronic display.

19. The apparatus of claim 18, wherein the received signal comprises a vertical blanking indicator (VBI).

20. The apparatus of claim 15, wherein a given frame packet includes a null command.
